(19) United States
(12) Patent Application Publication
(10) Pub. No.: US 2004/0068638 A1
(43) Pub. Date: Apr. 8, 2004

(54) Method, apparatus, and system for enhancing control flows in processors

(76) Inventors: Carl A. Alberola, Fremont, CA (US); Saleem Mohammadali, Bangalore (IN); Bapi Vinnakota, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/264,796

(22) Filed: Oct. 4, 2002

(51) Int. Cl. G06F 12/00

(52) U.S. Cl. 711/218; 711/154; 711/156

(57) ABSTRACT

According to one embodiment of the invention, an apparatus is provided which includes a set of comparators to compare each address of flow-change instructions identified in a program against address of the current instruction as the program being executed. Each comparator generates a respective signal having a first value if the address of the respective flow-change instruction matches the address of the current instruction. Target addresses associated with the flow change instructions and a default address of the next instruction are provided as inputs to a multiplexer which selects either the default address or one of the target addresses as the next instruction address, based on the signals generated by the comparators.

### FIELD

An embodiment of the invention relates to the field of processor architecture and implementation, and more specifically, relates to a method, apparatus, and system for enhancing control flows in processors.

### BACKGROUND

In recent years, computer systems' performance and capabilities have continued to advance rapidly in light of various technological advances and improvements with respect to processor architecture and execution of instructions. Typically, the routine flow of instruction addresses in program execution is linear. Non-linear flow changes are enabled by certain instructions such as branch instructions. However, the execution of branch instructions incur processing overhead (e.g., branch-use penalty slots). For example, the instructions at the start of the target of the branch segment cannot be immediately executed after the branch instruction. It is well known in the art that the control flow required for common programming constructs such as loops, nested loops, and multi-way decision processes can be realized in software using branch instructions. However, if no useful operations or instructions can be executed in the penalty slots incurred by the branch instructions, the overhead from the penalty slots will negatively affect the system performance (e.g., increase in program execution time).

### BRIEF DESCRIPTION OF THE DRAWINGS

The invention may best be understood by referring to the following description and accompanying drawings that are used to illustrate embodiments of the invention. In the drawings:

FIG. 1 shows a block diagram of a system according to one embodiment of the invention;

FIG. 2 illustrates a block diagram of an apparatus for enabling automatic flow change in program execution in accordance with one embodiment of the invention;

FIG. 3 shows a block diagram of an apparatus for updating iteration count according to one embodiment of the invention; and

FIG. 4 shows a flow diagram of a method according to one embodiment of the invention.

### DETAILED DESCRIPTION

In the following detailed description numerous specific details are set forth. However, it is understood that embodiments of the invention may be practiced without these specific details.

As mentioned above, the control flow required for common programming constructs such as loops, nested loops, and multi-way decision processes can be implemented in software using branch instructions. However, branch instructions incur processing overhead (e.g., penalty slots) which lead to an increase in the execution time. According to one embodiment of the invention, the branch-penalty overhead for common constructs can be reduced through hardware support. The hardware support will enable non-linear control flow without the overhead of branch instructions and the corresponding penalty slots. In one embodiment of the invention, the hardware support can be used to:

(1) Keep track of flow control variables such as loop counts, start and end addresses;

(2) Provide automatic flow change so that there is no need for explicit branch instructions and delay slots.

The hardware support according to one embodiment of the invention can decrease the number of instructions needed to create non-linear program flows, as well as the penalty incurred for non-linear control flows.

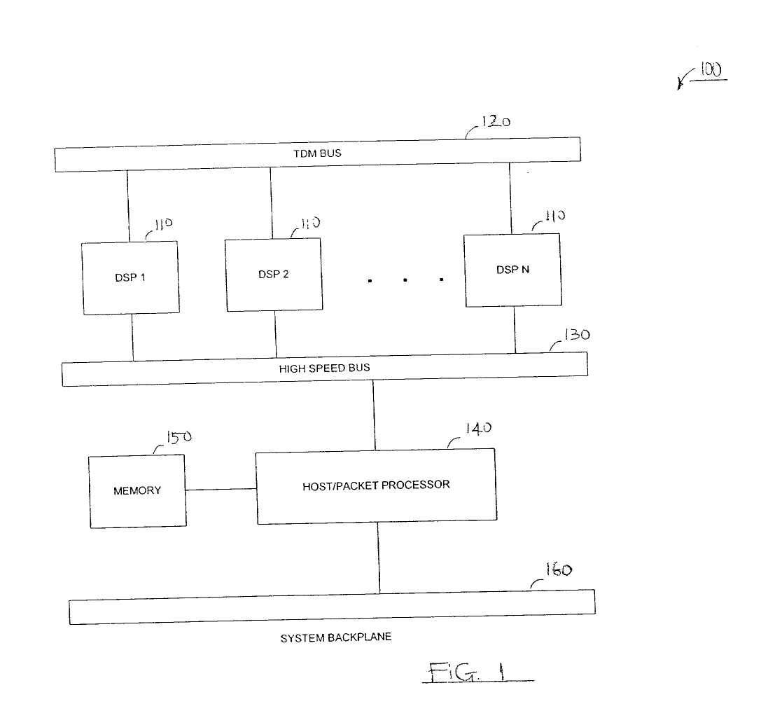

FIG. 1 illustrates a block diagram of one embodiment of an exemplary media processing system 100 in which the teachings of the invention are implemented. In one embodiment, the media processing system 100 includes one or more digital signal processing (DSP) units (also called digital signal processors) 110 that are coupled to a time-division multiplexing (TDM) bus 120 and a high-speed parallel bus 130. The media processing system 100 further includes a host/packet processor 140 that is coupled to a memory 150, the high-speed parallel bus 130, and system backplane 160. In one embodiment, the DSPs 110 are designed to support parallel, multi-channel signal processing tasks and include components to interface with various network devices and buses. In one embodiment, each DSP 110 includes a multi-channel TDM interface (not shown) to facilitate communications of information between the respective DSP and the TDM bus. Each DSP 110 also includes a host/packet interface (not shown) to facilitate the communication between the respective DSP and the host/packet processor 140. In one embodiment, the DSPs 110 perform various signal processing tasks for the corresponding media processing cards which may include voice compression/decompression (encoding/decoding), echo cancellation, dual-tone multi-frequency (DTMF) and tones processing, silence suppression (voice-activity-detection/comfort-noise-generation (VAD/CNG)), packetization and aggregation, jitter buffer management and packet loss recovery, etc.

In one embodiment, each DSP 110 and the host/packet processor 140 include hardware support mechanisms, which are described in more detail below, for non-linear control flow operations such as loops and multi-way decision constructs. As described herein, the hardware support mechanisms in accordance with one embodiment of the invention will enable non-linear control flows without incurring the overhead of branch instructions and corresponding penalty slots associated with branch instructions. In one embodiment of the invention, an instruction-address comparison method using hardware logic is implemented to signal when a flow change and iteration count update is necessary. This method allows for complex linear flows and multiple non-linear flows to be active simultaneously. In addition, this method does not restrict the size of the segment(s) with non-linear flows. Furthermore, this method allows interrupts to be serviced even during complex non-linear flows and allows the flow context to be saved and restored by the real time operating system.

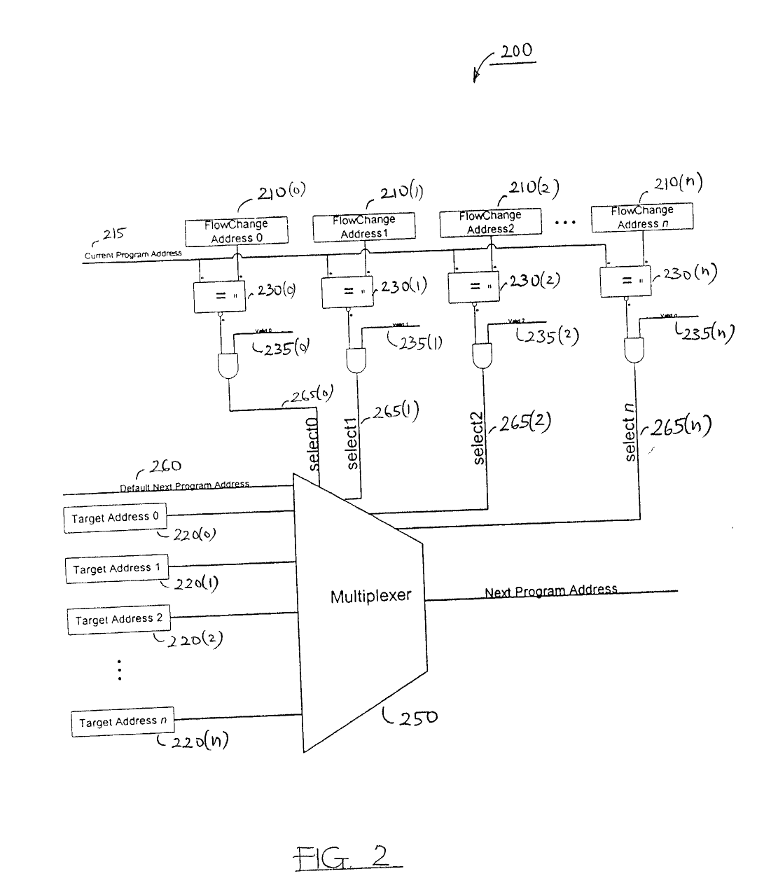

FIG. 2 illustrates a functional block diagram of an apparatus (also called hardware logic) 200 that can be implemented in DSP 110 or host/packet processor 140 for enabling automatic flow change in program execution, in accordance with one embodiment of the invention. As shown in FIG. 2, the apparatus 200 includes a set of registers 210 for storing addresses of flow-change instructions. Registers 210 are also called flow-change instruction address registers herein. The apparatus 200 also includes a set of registers 220 for storing the target addresses that are associated with the flow-change instruction addresses stored in registers 210. Registers 220 are also called go-to instruction address registers herein. In one embodiment, each address stored in a register 220 is the target address for each corresponding flow-change address stored in a register 210. The apparatus 200 further includes a set of multi-bit comparators 230 to compare each flow-change instruction address stored in registers 210 against the current instruction address (also called current program address) 215. In one embodiment, a set of state bits (also called valid bits herein) 235 are used to indicate which flow-change instruction addresses (e.g., loop and if-then-else instruction addresses) are active. Multiplexer 250 is used to select either the default next program address 260 or one of the target addresses as the next program address, based on the values of the select signals 265. In one embodiment, the values of the select signals are derived from the values of the state bits and the outputs from the multi-bit comparators 230. For example, if there is a match between the current program address 215 and the flow-change instruction address 0, then the target address associated with this flow-change instruction address (target address 0 in this example) is chosen or selected by the multiplexer 250 as the next instruction address (also called next program address), assuming that the corresponding state bit is active.

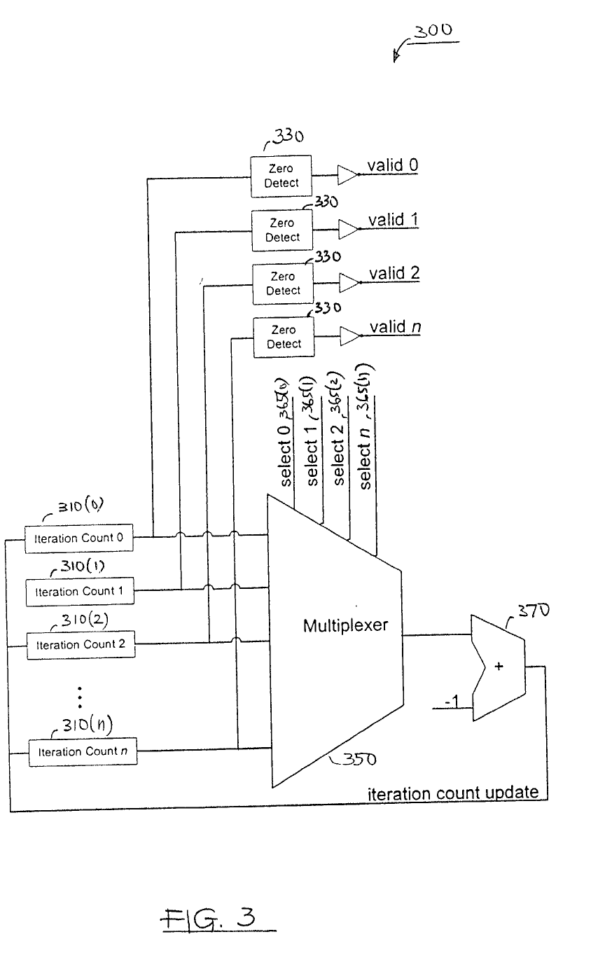

FIG. 3 shows a block diagram of an apparatus (also called hardware logic) 300 for updating iteration count for loop constructs, according to one embodiment of the invention. As shown in FIG. 3, the apparatus 300 includes a set of registers 310 each of which is used to store an iteration count (the number of iterations) for a corresponding iterative construct (e.g., a loop construct). The apparatus 300 includes multiplexer 350 to select one of the iteration counts based on the corresponding select signals 365. The selected iteration count is decremented by a decrementer 370 which is then fed back to the corresponding register 310 to be updated again until the respective iteration count reaches a predetermined value (e.g., zero).

The hardware support mechanisms illustrated in FIGS. 2-3 and described above are used to provide enhanced control flows which improve the speed of program execution and overall system performance. In operation, when a flow control or flow-change instruction is specified in software, the hardware logic described herein will automatically store into the corresponding registers the appropriate flow control information (e.g., flow control variables) such as the following:

(1) The number of iterations (iteration counts) if the construct is iterative (e.g., loop constructs). As described above, the number of iterations can be stored in one of the registers 310 shown in FIG. 3.

(2) The instruction address at which a flow change is necessary. As described above, the flow-change instruction address can be stored in one of the registers 210 illustrated in FIG. 2.

(3) The target address associated with the flow-change instruction address. As described above, the target address can be stored in one of the registers 220 shown in FIG. 2.

(4) The state bits that specify or indicate which flow addresses are active.

In one embodiment of the invention, as the program advances, the hardware support mechanism described above will automatically compare each active flow-change instruction address with the current instruction address (also called current program address). When there is a match, the target address associated with the respective flow-change instruction address is chosen as the next instruction address (also call next program address), as shown in FIG. 2 and described above. In the case of an iterative construct such as a loop construct, the associated iteration count is decremented using the iteration count update logic as illustrated in FIG. 3 and described above. In one embodiment, when the respective iteration count reaches a predetermined number (e.g., zero), the active state is cleared for that group of flow control registers, the respective flow-change instruction address is removed from the compare list, and the corresponding flow control registers are freed up for another flow control operation.

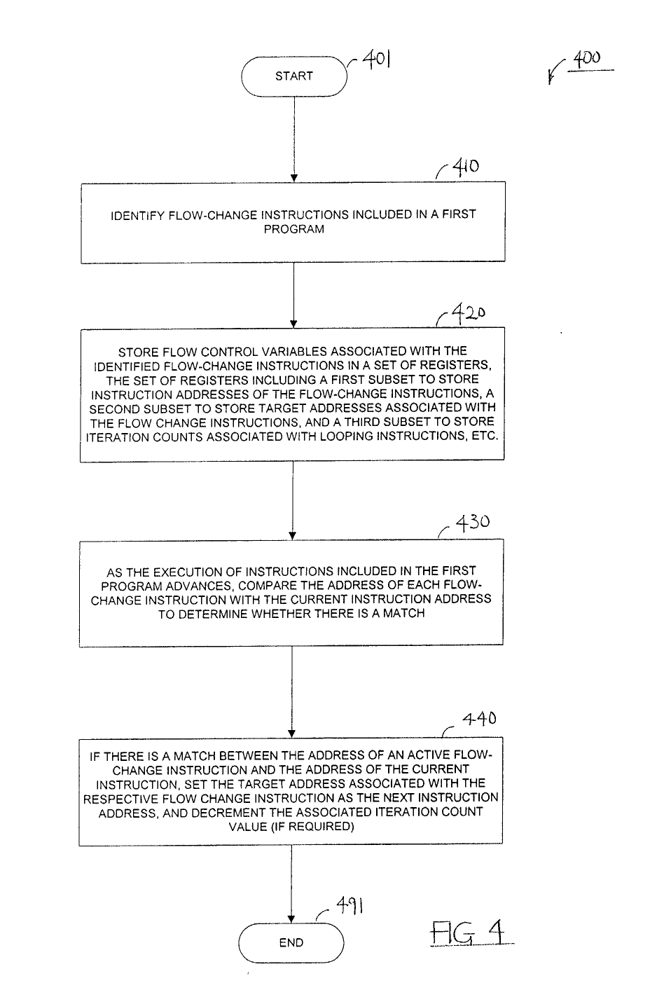

FIG. 4 shows a flow diagram of a method according to one embodiment of the invention. At block 410, flow change instructions included in a program to be executed by a processor such as one of the DSPs described above are identified. At block 420, the control variables associated with the identified flow change instructions (e.g., flow change instruction addresses, target addresses associated with the flow change instruction addresses, etc.) are stored in a set of registers In one embodiment, the set of registers to store the control variables may include a first subset of registers to store the flow change instruction addresses, a second subset of registers to store the target addresses associated with the flow change instruction addresses, a third subset of registers for storing iteration counts associated with looping instructions, etc. At block 430, as execution of the program advances, compare the addresses of the flow change instructions with the current instruction address to determine whether there is a match. At block 440, if there is a match between the current instruction address and an active flow change instruction address, set the target address associated with the respective flow change instruction address as the next instruction address, and decrement the iteration count associated with the respective flow change instruction address.

As described above, the various hardware support mechanisms and methods according to one embodiment of the invention allow for the following functionalities:

(1) They allow for multiple nonlinear flows to be active simultaneously as well as support for complex flow control structures that may require multiple branches;

(2) They allow for general nesting of flow control structures. Multiple flow control operations can be nested because each nonlinear flow can be described by an independent start address (target address), end address (flow change address), and iteration count;

(3) They allow for nonlinear flows to be interrupted;

(4) They allow for the flow context to be saved and restored by a real time operating system running on the processor; and

(5) No restrictions are placed on the size of the loop or the code within the multi-way decision blocks. For example, the number of instructions in a loop can be as low as one and the multi-way decision blocks can be of size zero.

While the invention has been described in terms of several embodiments, those of ordinary skill in the art will recognize that the invention is not limited to the embodiments described herein. It is evident that numerous alternatives, modifications, variations and uses will be apparent to those of ordinary skill in the art in light of the foregoing description.

What is claimed is:

1. An apparatus comprising:
a first set of comparators to compare addresses of flow-change instructions against address of a current instruction, at least one comparator to generate a respective signal having a first value in response to the address of a respective flow-change instruction matching the address of the current instruction; and
a first multiplexer coupled to receive a default address for a next instruction and target addresses of the flow-change instructions, the multiplexer to select either the default address or one of the target addresses as the next instruction address, based on the signals generated by the comparators.

2. The apparatus of claim 1 further including:
a first set of registers to store the addresses of the flow-change instructions, each register being coupled to a corresponding comparator.

3. The apparatus of claim 1 further including:
a second set of registers to store the target addresses of the flow-change instructions.

4. The apparatus of claim 1 wherein the first multiplexer includes a number of select signals which correspond to the number of addresses of flow change instructions, each select signal of the multiplexer being set and reset based on the value of the corresponding signal generated by the respective comparator and the value of a state bit indicating whether the corresponding address of the respective flow change instruction is valid.

5. The apparatus of claim 1 further including:
a third set of registers each of which to store a specified number of iterations associated with a respective looping instruction, the specified number of iterations associated with each looping instruction being updated iteratively during execution of the respective looping instruction.

6. The apparatus of claim 5 further including:
a second multiplexer coupled to the third set of registers to select, as its corresponding output, one of the numbers of iterations stored in the third set of registers based on the second multiplexer's select signals; and
a decrementer coupled to the output of the second multiplexer and to the third set of registers, the decrementer to decrement the selected number of iterations during each iteration of the respective looping instruction and feedback the decremented number to the corresponding register in the third set.

7. A method comprising:
detecting flow change instructions specified in a software program;
storing corresponding flow control variables associated with the flow change instructions in one or more sets of registers;
tracking the flow control variables using hardware logic; and
providing automatic flow change in the software program using hardware logic.

8. The method of claim 7 wherein flow control variables include instruction addresses associated with the flow change instructions.

9. The method of claim 7 wherein the flow control variables include target addresses associated with the flow change instructions.

10. The method of claim 7 wherein the flow control variables include a number of iterations associated with each flow change instruction having a loop construct.

11. The method of claim 7 wherein the flow control variables include state bits indicating which flow addresses are active.

12. The method of claim 7 wherein providing automatic flow change includes:
comparing the address of each active flow change instruction with the address of a current instruction; and
in response to a detection that there is a match between the address of a respective flow change instruction and the address of the current instruction, choosing the target address associated with the respective flow change instruction as the next instruction address in the software program.

13. The method of claim 12 further including:
if the respective flow change instruction is a looping instruction, decrementing the iteration count associated with respective flow change instruction.

14. The method of claim 13 further including:
indicating that the respective flow change instruction is no longer active and freeing the registers associated with the respective flow change instruction to be used for another flow change instruction, when the iteration count for the respective flow change instruction reaches a predetermined number.

15. A system comprising:
a memory to store a set of instructions and associated data; and
a digital signal processor (DSP) coupled to the memory, the DSP to execute the set of instructions stored in the memory, the DSP including:
a set of registers to store flow control variables associated with flow-change instructions included in the set of instructions, the set of registers including a first subset of registers to store addresses of the flow-change instructions and a second subset of registers to store target addresses associated with the flow-change instructions;
a set of comparators to compare addresses of the flow-change instructions against address of a current instruction, each comparator to generate a respective signal having a first value in response to the address of a respective flow-change instruction matching the address of the current instruction; and
a first multiplexer coupled to receive a default address for a next instruction and target addresses of the flow-change instructions, the first multiplexer to select either the default address or one of the target addresses as the next instruction address, based on the signals generated by the comparators.

16. The system of claim 15 wherein the set of registers further including:
a third subset of registers each of which is used to store a number of iterations associated with a flow-change instruction having a loop construct; and
a fourth subset of registers each of which is used to store a state bit associated with a corresponding flow-change instruction, the state bit being used to indicate whether the corresponding flow-change instruction is active.

17. The system of claim 15 wherein the first multiplexer includes a number of select signals which correspond to the number of addresses of flow change instructions, each select signal of the multiplexer being set and reset based on the value of the corresponding signal generated by the respective comparator and the value of a state bit indicating whether the corresponding address of the respective flow change instruction is valid.

18. The system of claim 16 further including:
a second multiplexer coupled to the third subset of registers to select, as its corresponding output, one of the numbers of iterations stored in the third subset of registers based on the second multiplexer's select signals; and
a decrementer coupled to the output of the second multiplexer and to the third subset of registers, the decrementer to decrement the selected number of iterations during each iteration of the respective flow change instruction and feedback the decremented number to the corresponding register in the third subset.
